(19) United States
(12) Patent Application Publication
(10) Pub. No.: US 2014/0340300 A1
(43) Pub. Date: Nov. 20, 2014

(54) SYSTEM AND METHOD FOR USING HANDHELD DEVICE AS WIRELESS CONTROLLER

(71) Applicant: ROLOCULE GAMES PRIVATE LIMITED, Pune (IN)

(72) Inventors: Suhel Momin, Pune (IN); Rohit Gupta, Pune (IN)

(73) Assignee: ROLOCULE GAMES PRIVATE LIMITED, Pune (IN)

(21) Appl. No.: 14/011,769

(22) Filed: Aug. 28, 2013

(30) Foreign Application Priority Data
May 17, 2013 (IN) 1765/MUM/2013

(51) Int. Cl. G06F 3/03

(52) U.S. Cl. CPC G06F 3/03
USPC 345/156

(57) ABSTRACT

A method and system for using handheld device (100) as a wireless controller is provided. The method includes, receiving at least of roll data (208), pitch data (210), yaw data (212) and acceleration data (214) corresponding to the handheld device (100); determining one or more actions to be performed based on one or more values of the at least of roll data (208), pitch data (210), yaw data (212) and acceleration data (214); and enabling performance of actions that are displayed on at least one display that is discrete from the handheld device (100).

### BACKGROUND

1. Field of the Disclosure

In general, the disclosure relates to the field of wireless controllers. More particularly, but not exclusively, the disclosure relates to the field of wireless controllers used in video gaming.

2. Discussion of Related Field

Over the past decade, the video gaming industry has witnessed substantial growth. A considerable number of video games are played on handheld devices. Such handheld devices can be devices that are specifically designed to play video games. Alternatively, the handheld devices can be mobile devices, such as, feature phone, smart phones and tablets, among others. Such handheld devices include a display and several controls. The games are installed on the handheld device and can be displayed on the handheld device. A user of the handheld device operates the controls provided in the handheld device to play games. While such a methodology of gaming is fairly popular, the size of display in such handheld devices is relatively small. Smaller display has a negative impact on the user experience, while playing video games.

The need for enabling users to play video games on larger display has been well appreciated by the video gaming industry. Video gaming consoles have been introduced for enabling users to play video games on larger display, such as a television. Typically, a console includes a processing unit, which can be connected to a television, and a wireless controller. The video games are typically stored on a data storage device, such as a Compact Disc (CD). A user typically installs the CD in the processing unit to play a video game. Further, the user uses the wireless controller to control various aspects of the game and play the game. The video game is displayed on the larger display, such as a TV, which is connected to the processing unit of the console.

In the aforementioned technology, the need for enabling users to play video games on larger display is addressed. However, the user will have to carry along the data storage devices (Example: CD), which has the video games, if the user wish to play the video games at different locations.

In relation to wireless controllers used in the aforementioned consoles, it is well known that they enable playing fairly advanced video games. The processing unit of the console is configured to trace the movement of the wireless controller, thereby enabling the user to play the game by moving the wireless controller. Typically, the wireless controller emits light, which is received by the processing unit, thereby enabling tracing of the wireless controller's movement. Hence, a user will have to purchase such wireless controller to be able to play video games on larger display.

In light of the foregoing discussion, there is a need for an alternative technique for enabling users to play mobile video games on larger display screens.

### SUMMARY

Accordingly the invention provides a method for using handheld device as a wireless controller. The method comprises receiving at least of roll data, pitch data, yaw data and acceleration data corresponding to the handheld device; determining one or more actions to be performed based on one or more values of the at least of roll data, pitch data, yaw data and acceleration data; and enabling performance of actions that are displayed on at least one display that is discrete from the handheld device.

There is also provided a system for using handheld device as a wireless controller. The system comprises a control module, wherein the control module is configured to: receive at least of roll data, pitch data, yaw data and acceleration data corresponding to the handheld device; determine one or more actions to be performed based on one or more values of the at least of roll data, pitch data, yaw data and acceleration data; and enable performance of actions that are displayed on at least one display that is discrete from the handheld device.

There is also provided a computer program product comprising a computer readable medium having instructions encoded thereon, when executed by a handheld device, causes the handheld device to perform the operations comprising: receiving at least of roll data, pitch data, yaw data and acceleration data corresponding to the handheld device determining one or more actions to be performed based on one or more values of the at least of roll data, pitch data, yaw data and acceleration data; and enabling performance of actions that are displayed on at least one display that is discrete from the handheld device.

### BRIEF DESCRIPTION OF THE DRAWINGS

Embodiments are illustrated by way of example in the Figures of the accompanying drawings, in which like references indicate similar elements and in which:

FIG. 1 is a block diagram of an exemplary handheld device 100, in accordance with an embodiment;

FIG. 2a is a block diagram of an exemplary sensors module 110 that is configured to communicate with a control module 102, in accordance with an embodiment;

FIG. 2b is a block diagram of another exemplary sensors module 110 that is configured to communicate with the control module 102, in accordance with an embodiment;

FIG. 3 is a block diagram of an exemplary control module 102 that is configured to enable controlling of video games using the handheld device 100, in accordance with an embodiment;

FIG. 4a depicts the possible yaw values in Radian, in accordance with an embodiment;

FIG. 4b is an exemplary illustration of a first orientation 602 of the handheld device 100, when reception of yaw data is initiated, in accordance with an embodiment;

FIG. 4c is an exemplary illustration of the handheld device 100 held in the instructed orientation, in accordance with an embodiment;

FIG. 5 is a flow chart of an exemplary method for calibrating yaw data, in accordance with an embodiment;

FIG. 6 is a flow chart of an exemplary method for determining the normalization factor, in accordance with an embodiment;

FIG. 7 is a flow chart of an exemplary method for normalizing yaw values during a gaming session, in accordance with an embodiment;

FIG. 8 is a flow chart of an exemplary method for determining short hand using yaw value, in accordance with an embodiment; and

FIG. 9 is a flow chart of an exemplary method for determining short type using roll value, in accordance with an embodiment.

### DETAILED DESCRIPTION OF PREFERRED EMBODIMENTS

I. OVERVIEW
II. EXEMPLARY SYSTEM ARCHITECTURE OF A HANDHELD DEVICE
III. EXEMPLARY BLOCK DIAGRAM OF A SENSORS MODULE
IV. ANOTHER EXEMPLARY BLOCK DIAGRAM OF THE SENSORS MODULE
V. EXEMPLARY METHOD TO USE DATA RECEIVED FROM THE SENSORS MODULE
VI. EXEMPLARY BLOCK DIAGRAM OF A CONTROL MODULE
VII. FLOWCHART OF AN EXEMPLARY METHOD FOR CALIBRATING YAW VALUE
VIII. FLOWCHART OF AN EXEMPLARY METHOD FOR NORMALIZING YAW VALUES DURING A GAMING SESSION
IX. A FIRST EXAMPLE OF USING DATA RECEIVED FROM THE SENSORS MODULE

### I. Overview

The following detailed description includes references to the accompanying drawings, which form a part of the detailed description. The drawings show illustrations in accordance with example embodiments. These example embodiments are described in enough detail to enable those skilled in the art to practice the present subject matter. However, it will be apparent to one with ordinary skill in the art that the present invention may be practiced without these specific details. In other instances, well-known methods, procedures, components, and networks have not been described in detail so as not to unnecessarily obscure aspects of the embodiments. Within the scope of the detailed description and the teachings provided herein, additional embodiments, application, features, and modifications are certainly are recognized by a person skilled in the art. Therefore, the following detailed description is not to be taken in a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### II. Exemplary System Architecture of a Handheld Device

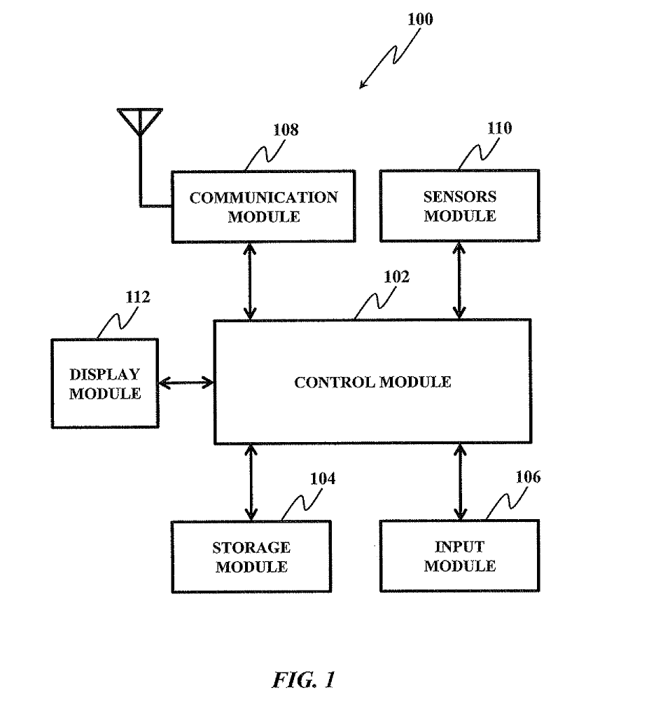

FIG. 1 is a block diagram of an exemplary handheld device 100, in accordance with an embodiment. The handheld device 100, for example, can be a feature phone, smart phone or tablet, among other such devices. The handheld device 100 includes a control module 102, a storage module 104, an input module 106, a communication module 8108, a sensors module 110 and a display module 112.

The control module 102 can include an Application-Specific Integrated Circuit (ASIC). In another embodiment, the control module 102 can include a microprocessor. The control module 102 can access instructions that may be stored in the storage module 104. Further, the control module 102 can receive inputs from other modules/units of the handheld device 100. The control module 102 processes the inputs as per the instructions and controls operation of one or more modules/units of the handheld device 100.

The storage module 104, for example, can include, read-only memory (ROM), random-access memory (RAM), subscriber identity module (SIM), optical data storage devices and hard disks. The storage module 104 stores instructions that can be retrieved by the control module 102 for controlling the operation of the handheld device 100. The storage module 104 stores data generated during the operation of the handheld device 100. Further, data that may be required for subsequent retrieval is also stored in the storage module 104.

The input module 106 is configured to receive inputs from input means, such as, keypad, microphone and touch sensitive display, among others.

The communication module 108 is configured to transmit and receive data using communication channels. The communication module 108 for example, can be configured to communicate date with a television, using radio frequency.

The sensors module 110 includes sensors, such as, gyroscope and accelerometer. The sensors module 110 can also include magnetometer. These sensors sense the movement of the handheld device 100, and communicate respective data to the control module 102.

The display module 112 displays still images, moving images and characters. The display module 112 can be, for example, a LCD display or LED display, among others.

The handheld device 100 is configured to be used as a wireless controller for playing games, which will be displayed on a large display, such as a television. The handheld device 100 uses data received by the sensors module 110 to control video games. The video games that are controlled can be mobile games, such as, for example, tennis, table-tennis, badminton, baseball, cricket, fishing, fitness and rhythm games, dance simulation game, aerobics fitness, shooting games, point and shoot games, first person shooters, third person shooters, archery, sword fighting, Frisbee and disc throwing games, among others.

### III. Exemplary Block Diagram of a Sensors Module

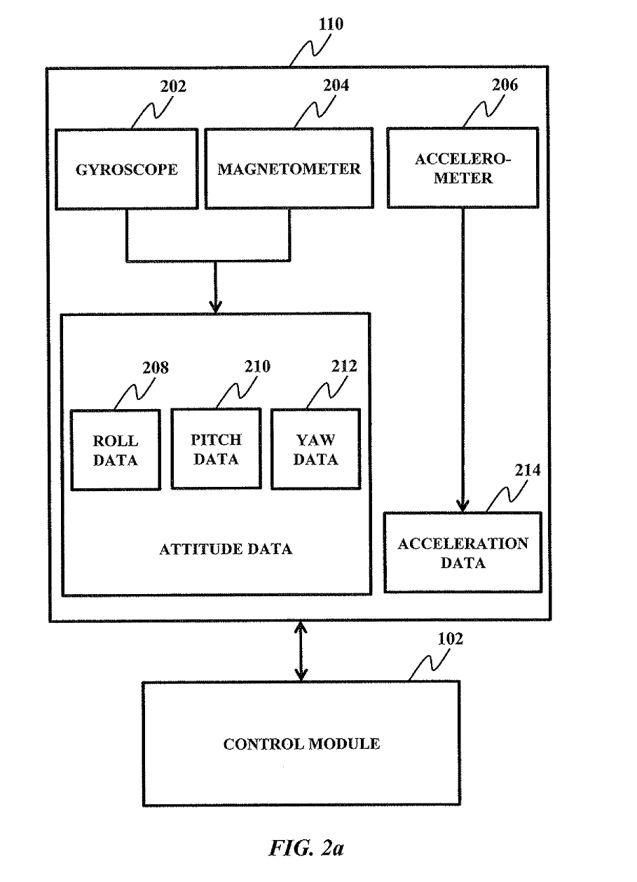

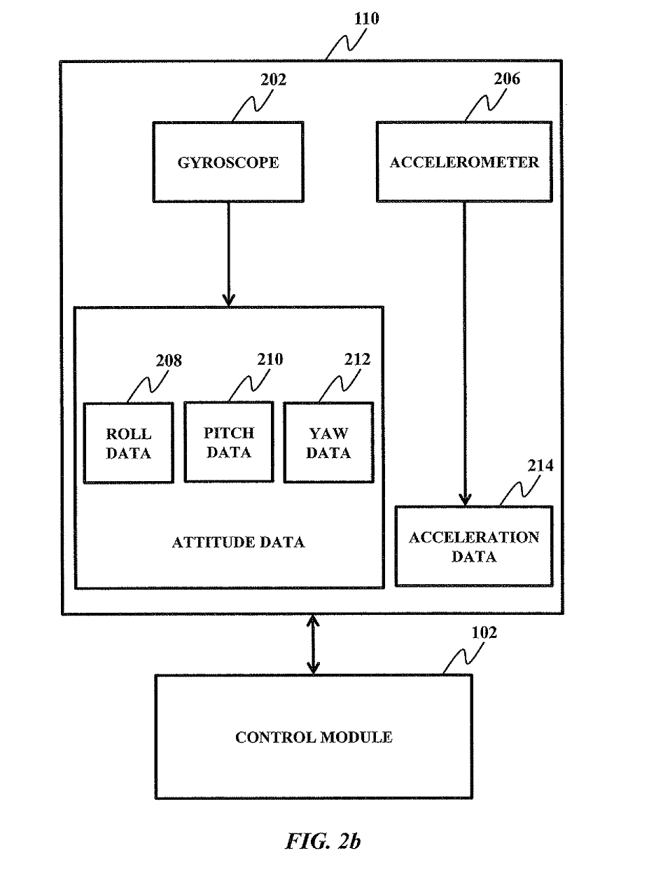

FIG. 2a is a block diagram of an exemplary sensors module 110 that is configured to communicate with the control module 102, in accordance with an embodiment. The sensors module 110 includes a gyroscope 202, a magnetometer 204 and an accelerometer 206. The gyroscope 202 and the magnetometer 204 generate roll data 208, pitch data 210 and yaw data 212. The roll data 208, pitch data 210 and yaw data 212 can be collectively referred to as attitude data. The accelerometer 206 generates acceleration data 214. The attitude data and acceleration data 214 is communicated to the control module 102, which processes the data to control the video game.

### IV. Another Exemplary Block Diagram of the Sensors Module

FIG. 2b is a block diagram of another exemplary sensors module 110 that is configured to communicate with the control module 102, in accordance with an embodiment. The sensors module 110 includes a gyroscope 202 and an accelerometer 206. The gyroscope 202 generates the attitude data, while the accelerometer 206 generates acceleration data 214. The attitude data and acceleration data 214 is communicated to the control module 102, which processes the data to control the video game.

### V. Exemplary Method to Use Data Received From the Sensors Module

In an embodiment, the control module 102 is configured to process data received from the sensors module 110. The control module 102 includes an action library. The action library includes actions to be performed, for example in the video game that may be displayed on a television. The control module 102 processes data received from the sensors module 110 to control actions, which are displayed at least on a display, such as a television, which is discrete from the handheld device 100. The control module 102 after receiving the data from the sensors module 110 determines the one or more actions to be performed by querying the action library.

In an embodiment, each action in the action library is based on values corresponding to one or more of roll data, pitch data, yaw data and acceleration data.

In an embodiment, each action in the action library is based on change in values corresponding to one or more of roll data, pitch data, yaw data and acceleration data.

In an embodiment, each action in the action library is based on range of values corresponding to one or more of roll data, pitch data, yaw data and acceleration data.

In an embodiment, the control module 102 performs the action in the handheld device 100, which is displayed on a device, which has a relatively larger display, such as a television.

In an embodiment, the control module 102 communicates the data received from the sensors module 110, to an external device, such as a set top box. The external device can include the action library, which queries the action library, and actions are performed based on the data received from the control module 102 and the action library.

In an embodiment, the control module 102 communicates the data received from the sensors module 110, to an external device, such as a television. The external device can include the action library, which queries the action library, and actions are performed based on the data received from the control module 2102 and the action library.

In an embodiment, sensor data, such as the yaw data is normalized, so that the actions can be performed accurately.

### VI. Exemplary Block Diagram of a Control Module

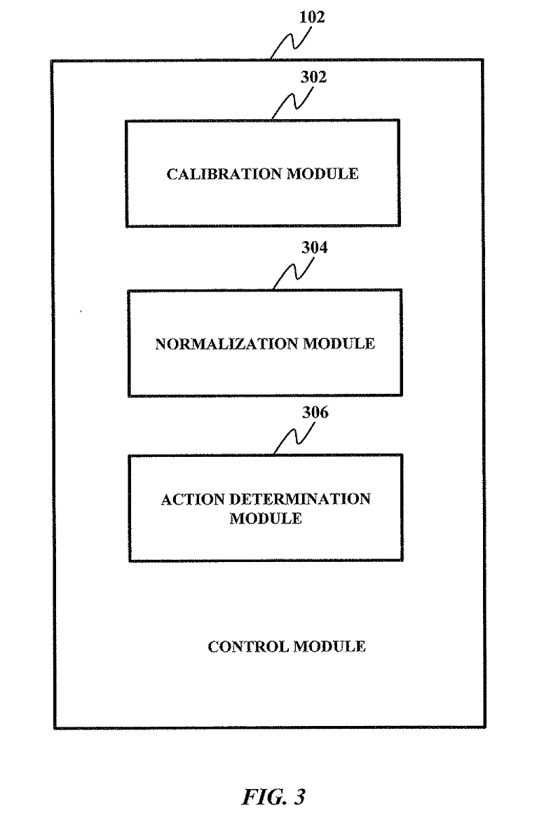

FIG. 3 is a block diagram of an exemplary control module 102 that is configured to enable controlling of video games using the handheld device 100, in accordance with an embodiment. The control module 102 includes a calibration module 302, a normalization module 304 and an action determination module 306.

The calibration module 302 calibrates yaw value by determining a normalization factor that is applied to yaw data, which is received from the sensors module 110. The normalization factor is used to determine normalized yaw value, which is used to accurately control video games.

The normalization module 304 determines normalized yaw values by using the normalization factor and the yaw data, which is received from the sensors module 110.

The action determination module 306 uses the yaw values, pitch data, roll data and acceleration data to determines the actions to be effected in the video game that is being played and controlled using the handheld device 100.

### VII. Flowchart of an Exemplary Method for Calibrating Yaw Value

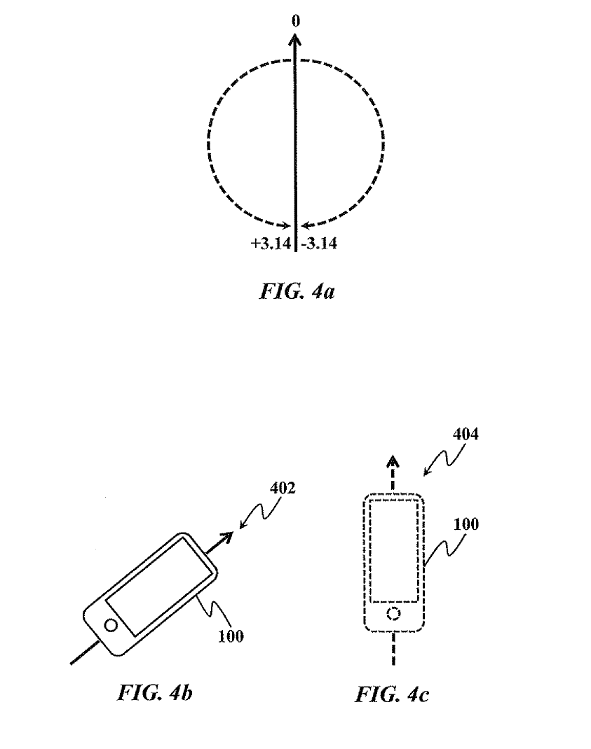

Yaw value, as indicated in FIG. 4a, varies between 0 Radian to +3.14 Radian, and 0 Radian to −3.14 radian. The yaw value changes if a device, such as the handheld device 100, changes orientation in either directions. It shall be noted that, 0 Radian of yaw is not fixed. The yaw value is set to 0 Radian when reception of yaw data is initiated. FIG. 4b is an exemplary illustration of a first orientation 402 of the handheld device 100, when reception of yaw data is initiated, in accordance with an embodiment. At the first orientation 402 of the handheld device 100, the yaw value is set to zero. It shall be noted that the orientation at which reception of yaw data is initiated can vary almost every time the handheld device 100 is used to control video games. Hence, controlling of games using this yaw data is not possible. Hence, conventionally, yaw data does not seem to have been used for controlling games using handheld devices, such as smart phones.

In order to use yaw data for controlling games using the handheld device 100, yaw value is calibrated subsequent to initiation of reception of yaw data. In order to calibrate the yaw value, subsequent to initiation of reception of yaw data, user of the handheld device 100 is requested to hold the handheld device 100 as per an instructed orientation. FIG. 4c is an exemplary illustration of the handheld device 100 held in the instructed orientation 404, in accordance with an embodiment. The instructed orientation 404, can be, for example, holding the handheld device 100 perpendicular to the plane of a television on which the video game is being displayed. The yaw value at the instructed orientation is used to calibrate yaw data, thereby enabling usage of yaw data for controlling games using the handheld device 100.

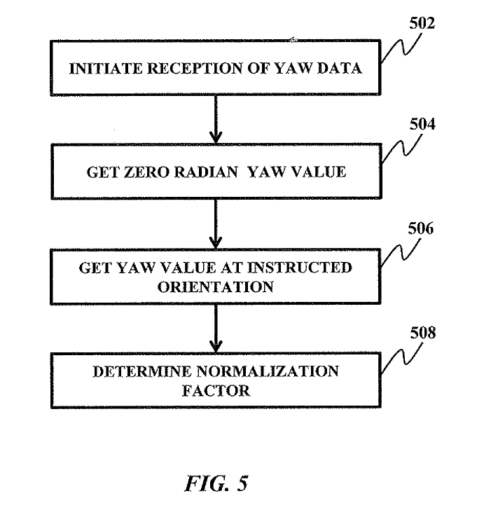

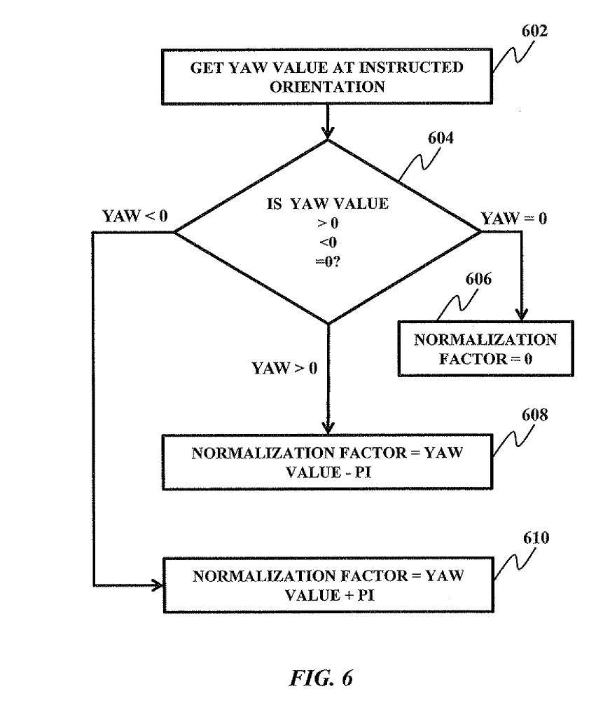

FIG. 5 is a flow chart of an exemplary method for calibrating yaw data, in accordance with an embodiment. At step 502, reception of yaw data from the sensors module 110 is initiated. As soon as the reception of yaw data from the sensors module 110 is initiated, yaw value of 0 Radian is assigned to the orientation of the handheld device 110 at which the reception was initiated (step 504). Subsequently, the user orients the handheld device 100 to an instructed orientation. At step 506, the yaw value with the handheld device 100 held as per the instructed orientation is recorded. The yaw value that is recorded with the handheld device 100 held as per the instructed orientation is used to determine a normalization factor (step 508).

It shall be noted that, a user, although instructed to hold the handheld device 100 as per the instructed orientation, may not be holding the handheld device 100 as per the instructed orientation. However, if the user, either explicitly or implicitly, provides an input that the handheld device 100 is held as per the instructed orientation, then the control module 102 determines the normalization factor as per the yaw value recorded at the instant orientation at which the handheld device 100 is held.

FIG. 6 is a flow chart of an exemplary method for determining the normalization factor, in accordance with an embodiment. At step 602, the yaw value is recorded when the handheld device 100 is held as per the instructed position. Subsequently, at step 604, a verification is carried out to determine whether the yaw value is greater than zero, less than zero or equal to zero. If it is determined that the yaw value is equal to zero, than at step 606, the normalization factor is set to zero. On the other hand, if at step 604, it is determined that normalization factor is greater than zero, than the normalization factor is calculated by subtracting PI, which is 3.14, from the yaw value (in Radian), which is recorded at step 602. Further, if at step 604, it is determined that normalization factor is less than zero, than the normalization factor is calculated by adding PI, which is 3.14, with the yaw value (in Radian), which is recorded at step 602.

The normalization factor is used to normalize yaw values that are received during a gaming session (the same session in which the instant normalization factor is determined) to control the game using the handheld device 100.

### VIII. Flowchart of an Exemplary Method for Normalizing Yaw Values During a Gaming Session

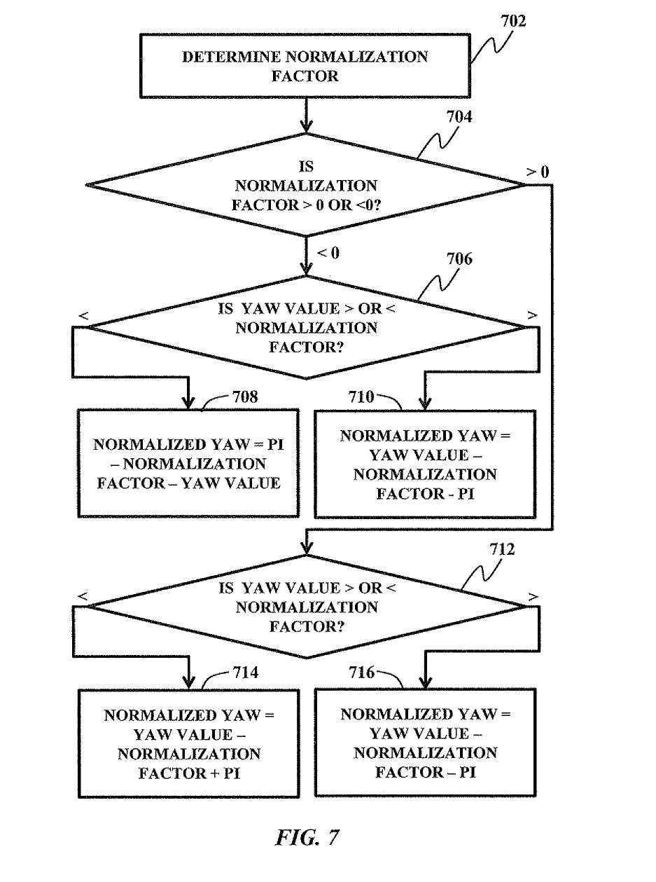

FIG. 7 is a flow chart of an exemplary method for normalizing yaw values during a gaming session, in accordance with an embodiment. At step 702, normalization factor is determined. At step 704, verification is carried out to check whether the normalization factor is greater than or less than zero. If the normalization factor is less than zero, then at step 706, it is verified whether yaw value that has to be normalized, which is collected during a gaming session, is greater than the normalization factor. If the yaw value is less than the normalization factor, then at step 708, normalized yaw value is determined subtracting normalization factor and yaw value from PI. On the other hand, if the yaw value is greater than the normalization factor, then at step 710, normalized yaw value is determined subtracting normalization factor and PI from yaw value.

Similarly, if at step 704, it is determined that normalization factor is greater than zero, then at step 712, it is verified whether yaw value that has to be normalized, which is collected during a gaming session, is greater than the normalization factor. If the yaw value is less than the normalization factor, then at step 714, normalized yaw value is determined subtracting the normalization factor from yaw value and PI. On the other hand, if the yaw value is greater than the normalization factor, then at step 716, normalized yaw value is determined by subtracting normalization factor and PI from yaw value.

The normalized yaw values, roll data, pitch data and acceleration data are used by the control module to control the video game using the handheld device 100.

### IX. A First Example of Using Data Received From the Sensors Module

In an embodiment, the data received from the sensors module 110 is used to control a video game, such as a tennis video game. In this example, the video game is included in the handheld device 100, which also includes the sensors module 110. The video game, while being processed in the handheld device 100, is displayed on a television. Therefore a gamer controls the video game using the handheld device 100, while the video game is displayed on the television.

The yaw value is calibrated and the subsequent yaw values are normalized, as explained earlier. Further, the gamer provides an input as to whether the handheld device is held in the right hand or the left hand. This instant input is used to determine the type of tennis shot that is being played by the gamer.

Further, each yaw value is de-scaled, by applying a de-scaling factor. The de-scaling factor can vary based on game requirements. In this example, de-scaled yaw may be referred to as yaw.

Additionally, the yaw value, which may be polar form is converted into Cartesian coordinates in X, Y and Z direction. The conversion can be carried out as provided below:
Direction Y=0.0;
Direction X=−Sin (yaw);
Direction Z=−Cos (yaw);

The above conversion provides the direction of the shot.

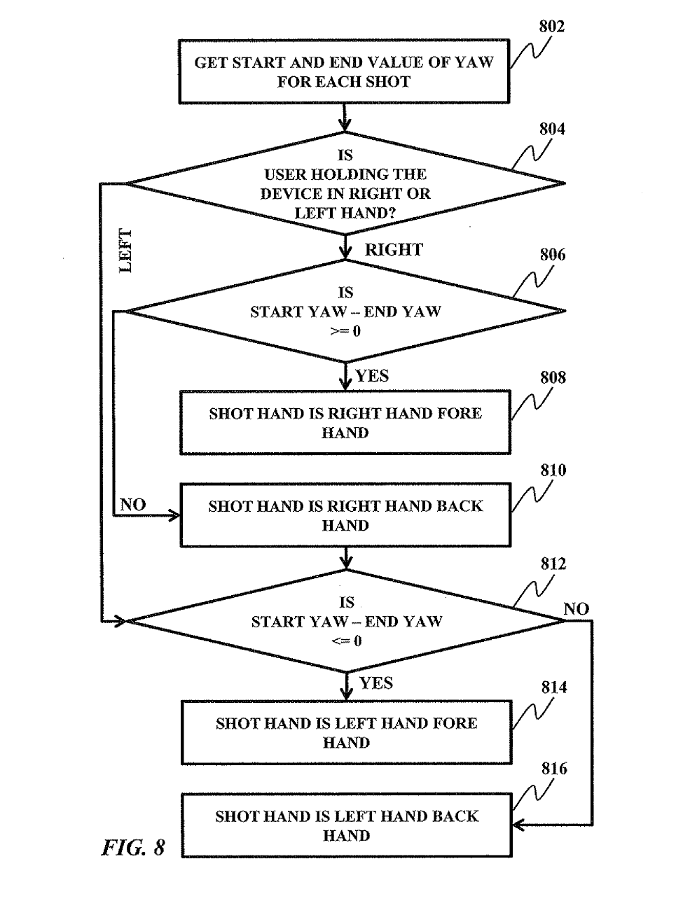

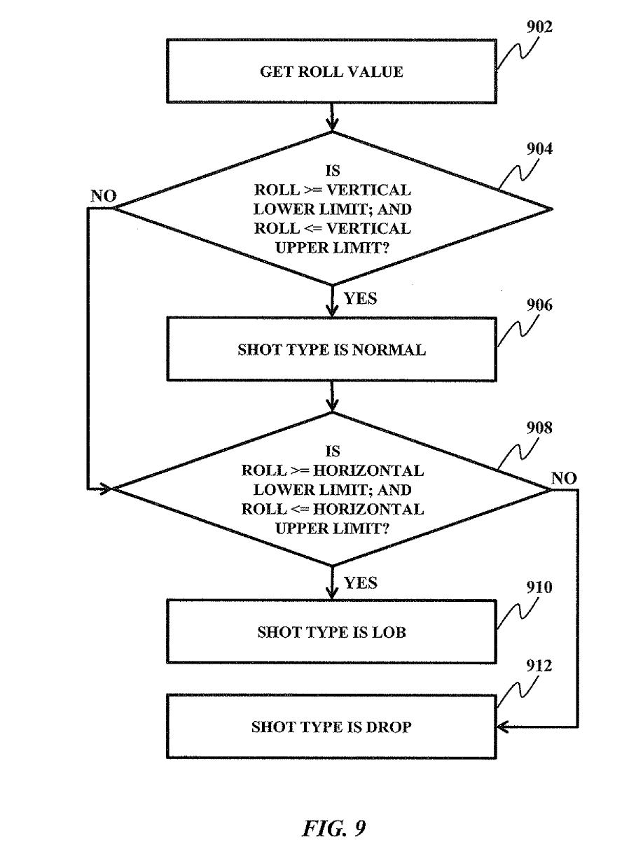

The yaw value is used to determine the shot hand in this tennis game. The shot hand, for example, is of four types, namely, right hand fore hand, right hand back hand, left hand fore hand and left hand back hand. FIG. 8 is a flow chart of an exemplary method for determining short hand using yaw value, in accordance with an embodiment. At step 802, start and end value of yaw is recorded by the control module 102. Further, at step 804, the control module 102 checks whether the handheld device 100 is held in the right or left hand, which is an input provided by the user. If the handheld device 100 is held in the right hand, then the control module 102 determines whether the difference obtained by subtracting end value of yaw from the start value of yaw is greater or equal to zero, at step 806. If the instant difference is greater than or equal to zero, then the short hand is determined to be right hand fore hand, else the short hand is determined to be right hand back hand.

Alternatively, if the handheld device 100 is held in the left hand, then the control module 102 determines whether the difference obtained by subtracting end value of yaw from the start value of yaw is less than or equal to zero, at step 806. If the instant difference is less than or equal to zero, then the short hand is determined to be left hand fore hand, else the short hand is determined to be left hand back hand.

The control module 102 also determines the tennis shot type. The shot type, for example, can be, normal, drop and lob. The control module 102 determines the shot type using the roll value. The control module 102 can use average roll value to determine the shot type. In order to determine the shot type, vertical upper and lower limit for roll, and horizontal upper and lower limit for roll may be preset. The limits can be, for example, as provided below:

Vertical lower limit=0.8

Vertical upper limit=2.35

Horizontal lower limit=2.35

Horizontal upper limit=3.14

FIG. 9 is a flow chart of an exemplary method for determining short type using roll value, in accordance with an embodiment. At step 902, the control module 102 records the roll value. At step 904, the control module 102 checks, whether the roll value is greater than or equal to the vertical lower limit, and whether the roll value is lesser than or equal to the vertical upper limit. If the roll value is greater than or equal to the vertical lower limit, and the roll value is lesser than or equal to the vertical upper limit, then the shot type is determined to be a “normal” shot, at step 906.

If it is determined that, at least one of, the roll value is not greater than or equal to the vertical lower limit, and the roll value is lesser than or equal to the vertical upper limit, then at step 908, the control module 102 checks, whether the roll value is greater than or equal to the horizontal lower limit, and whether the roll value is lesser than or equal to the horizontal upper limit. If the roll value is greater than or equal to the horizontal lower limit, and the roll value is lesser than or equal to the horizontal upper limit, then the shot type is determined to be a “lob” shot, at step 910. Else, the shot type is determined to be a “drop” shot.

In light of the foregoing description, it shall be noted that the determination of shot direction, shot hand and shot type enables controlling the video game using the handheld device 100, while the game is displayed on a larger display screen, such as a television screen.

In an embodiment, acceleration data 214 is used to determine whether an action has to be performed or not. For example, threshold limits for acceleration data 214 are set for X, Y and Z axis. The control module 102 determines that an action, such as, playing of a tennis shot, has been performed. Subsequently, the control module 102 uses attitude data to query the action library for identifying the action to be performed.

In an embodiment, the control module 102 uses the acceleration data 214 for adding an attribute, such as speed of a shot, to an action. In an embodiment, the handheld device 100 is used as a wireless controller. The method of using the handheld device 100 as the wireless controller includes, receiving at least of roll data, pitch data, yaw data and acceleration data corresponding to the handheld device; determining one or more actions to be performed based on one or more values of the at least of roll data, pitch data, yaw data and acceleration data; and enabling performance of actions that are displayed on at least one display that is discrete from the handheld device.

In an embodiment, at least one of roll data, pitch data, yaw data and acceleration data corresponding to the handheld device is received by the control module 102. The control module determines one or more actions performed by a user who is using the handheld device, based on one or more values of the at least one of roll data, pitch data, yaw data and acceleration data. Further, the one or more actions performed by the user are compared with benchmark. The comparison can be used to take required decisions.

For example, a dance game can use the functions of the control module 102 to determine steps (actions) performed by a gamer who dances while holding the handheld device. Later, the steps can be compared with benchmark steps. Subsequently, the gamer can be informed about how well the gamer has performed with respect to the benchmark.

The processes described above is described as sequence of steps, this was done solely for the sake of illustration. Accordingly, it is contemplated that some steps may be added, some steps may be omitted, the order of the steps may be re-arranged, or some steps may be performed simultaneously.

In an embodiment, a computer program product is provided. The computer program product includes a computer readable medium. The computer readable medium includes instructions, that can be executed by a data processing system, such as, for example, a handheld device and a microprocessor. The execution of the instructions, causes the data processing system to operate as described herein.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention. Thus the scope of the invention should be determined by the appended claims and their legal equivalents rather than by the examples given herein.

We claim:

1. A method for using handheld device as a wireless controller, the method comprising:
receiving at least one of roll data, pitch data, yaw data and acceleration data corresponding to the handheld device;
determining one or more actions to be performed based on one or more values of the at least one of roll data, pitch data, yaw data and acceleration data; and
enabling performance of actions that are displayed on at least one display that is discrete from the handheld device.

2. The method according to claim 1, wherein the one or more actions is based on change in values corresponding to the one or more of roll data, pitch data, yaw data and acceleration data.

3. The method according to claim 1, wherein the one or more actions is based on range of values corresponding to the one or more of roll data, pitch data, yaw data and acceleration data.

4. The method according to claim 1, further comprising normalizing yaw data prior to determining the one or more actions.

5. The method according to claim 4, wherein the step of normalizing comprises determining yaw value corresponding to the handheld device when the handheld device is indicated to be held at an instructed position.

6. A method according to claim 1, wherein the method is used for controlling video game.

7. A system for using handheld device as a wireless controller, the system comprising a control module, wherein the control module is configured to:
receive at least one of roll data, pitch data, yaw data and acceleration data corresponding to the handheld device;
determine one or more actions to be performed based on one or more values of the at least one of roll data, pitch data, yaw data and acceleration data; and
enable performance of actions that are displayed on at least one display that is discrete from the handheld device.

8. The system according to claim 7, wherein the one or more actions is based on change in values corresponding to the one or more of roll data, pitch data, yaw data and acceleration data.

9. The system according to claim 7, wherein the one or more actions is based on range of values corresponding to the one or more of roll data, pitch data, yaw data and acceleration data.

10. The system according to claim 7, wherein the control module is further configured to normalize yaw data prior to determining the one or more actions.

11. The system according to claim 10, wherein the control module is further configured to normalize yaw data by determining yaw value corresponding to the handheld device when the handheld device is indicated to be held at an instructed position.

12. A system according to claim 7, wherein the system is used for controlling video game.

13. A computer program product comprising a computer readable medium having instructions encoded thereon, when executed by a handheld device, causes the handheld device to perform the operations comprising:
receiving at least one of roll data, pitch data, yaw data and acceleration data corresponding to the handheld device;
determining one or more actions to be performed based on one or more values of the at least one of roll data, pitch data, yaw data and acceleration data; and
enabling performance of actions that are displayed on at least one display that is discrete from the handheld device.

14. A method for using handheld device as a wireless controller, the method comprising:
receiving at least one of roll data, pitch data, yaw data and acceleration data corresponding to the handheld device; and
determining one or more actions performed by a user using the handheld device, based on one or more values of the at least one of roll data, pitch data, yaw data and acceleration data.

15. The method according to claim 14, further comprising comparing the one or more actions performed by the user with benchmark.

16. A system for using handheld device as a wireless controller, the system comprising a control module, wherein the control module is configured to:
receive at least one of roll data, pitch data, yaw data and acceleration data corresponding to the handheld device; and
determine one or more actions performed by a user using the handheld device, based on one or more values of the at least one of roll data, pitch data, yaw data and acceleration data.

17. The system according to claim 16, wherein the control module is further configured to compare the one or more actions performed by the user with benchmark.

18. A computer program product comprising a computer readable medium having instructions encoded thereon, when executed by a handheld device, causes the handheld device to perform the operations comprising:
receiving at least one of roll data, pitch data, yaw data and acceleration data corresponding to the handheld device; and
determining one or more actions performed by a user using the handheld device, based on one or more values of the at least one of roll data, pitch data, yaw data and acceleration data.

19. The computer program product according to claim 18, wherein the handheld device compares the one or more actions performed by the user with benchmark.
